(19) United States
(12) Patent Application Publication
(10) Pub. No.: US 2007/0086182 A1
(43) Pub. Date: Apr. 19, 2007

(54) Horse safety headlight apparatus

(76) Inventor: Lee Ann Kelly, Palmdale, CA (US)

Correspondence Address: EDWIN TARVER, 16830 Ventura Blvd., SUITE 360, Encino, CA, 91436, US

(21) Appl. No.: 11/251,413

(22) Filed: Oct. 14, 2005

(51) Int. Cl. F21V 21/108

(52) U.S. Cl. 362/108; 362/103

(57) ABSTRACT

A nighttime safety light apparatus for use on a horse, comprising a battery powered compact light source and a pouch for holding the light source and securing it to the horse's breast collar. The pouch is formed of a single cross-shaped sheet wherein the horizontal members fold forward and inward forming the sides and part of the front of the pouch, the bottom vertical member folds forward and upward to form the bottom and front of the pouch, and the top vertical member folds down and over the front of the pouch and secures in place over a compact light source contained in the pouch. The top and bottom vertical members have openings which overlap when the pouch is closed, allowing the cowl of the light source to extend through the openings. The apparatus secures to the breast collar of a horse with attached straps.

### CROSS-REFERENCE TO RELATED APPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to safety accessories, and more particularly to equestrian safety accessories, and specifically, to a headlight and pouch that can be releasably secured to the breast collar of a horse.

Safety is a primary concern while riding a horse at night. A passing motorist, even with a headlight on, may not be able to detect the horse and a rider at night. This situation may lead to fatal consequences injuring both the horse and the rider. The rider can use a flashlight to warn or hint the motorist. But holding the flashlight with one hand and controlling the horse with another may not be convenient to the rider. Illuminating devices that are attachable to the horse will overcome this problem. These devices can be designed to illuminate the path in front of the horse and also warn the oncoming motorist or pedestrians about the presence of the horse and the rider.

Several devices to illuminate the path before an animal during a night walk or ride are known in the art. For example, U.S. Pub. No. 20050099796 to Magee discloses a set of devices, high intensity light-emitting diodes (LEDs), for safety and/or illuminative lighting in conjunction with a horse or a similar animal. Batteries and wirings are included within the structure and the LEDs are fixed in an apparatus that is attachable to a horse's saddle or stirrup. Features including switching between high and low intensity light, flashing or blinking lights, and use of different color lights are also disclosed. Although the purpose of this device is similar, the means for supporting the device and the usage of LEDs are distinct.

U.S. Pat. No. 911,733 to Libby discloses a headlight attachment for horses that includes a lamp suspension means, which will receive various types of standard lamps. The device may be adjusted expeditiously to any horse. U.S. Pat. No. 878,898 to Richards also discloses a headlight and means for its attachment to the horse. However, the attaching means of the above devices are substantially different from the present invention.

U.S. Pat. No. 6,805,460 to Zoller discloses a dog collar flashlight for providing illuminating light sufficient to perceive and visually detect items on the ground and adjacent the animal to which the dog collar is attached. The angle of light enables the animal and the owner to see the oncoming path sufficiently soon in order to anticipate any obstacles. The invention is also generally applicable to any other domesticated animal. The dog collar flashlight of this invention may be incorporated into a collar or a harness. However, the structure and attaching means of the collar are different from the present invention.

Although numerous illuminating devices for animals such as the above devices serve the same purpose as that of the present invention, there is a need for relatively simple and convenient means to secure the illuminating device at a suitable location on a horse. Any light source mounted on or near the sides of the horse, such as flashlights, helmet lights, and carriage lights, will interfere its vision. Therefore the only way to illuminate the road without interfering with the horse's vision is to mount the light source centered directly beneath the neck of the horse, thereby improving safety during nighttime horse rides.

Therefore, it is an object of the present invention to provide an improved nighttime safety apparatus that can be releasably secured to the breast collar of a horse.

A further object is to provide an improved nighttime safety apparatus, which can be quickly and easily secured to any type of breast collar of a horse.

A further object is to provide an improved nighttime safety apparatus, which uses a light source that provides sufficient illumination for lengthy night rides on a horse.

A further object is to provide an improved nighttime safety apparatus, which uses a light source that includes a setting for a flashing signal light.

A further object is to provide an improved nighttime safety apparatus, which holds the light source in a suitable position to properly illuminate the path in front of the horse and to indicate oncoming motorists, other riders, or pedestrians about the presence of the horse and rider.

Finally, it is an object of the present invention to provide an improved nighttime safety apparatus, which facilitates quick removal of the light source to be used for other emergency purposes. These and other objects of the present invention will become better understood with reference to the appended Summary, Description, and Claims.

### SUMMARY

The present invention is directed to an improved nighttime safety apparatus for use on a horse that is easy to install, remains attached to the breast collar of the horse even as the light source is removed and replace, and is durable for nighttime horseback riding. The apparatus comprises a light source and a pouch for holding the light source. The pouch can be secured to the breast collar of the horse in a suitable position such that the light from the light source will not interfere the horse's vision. Any suitable state-of-the-art light source available in the market can be used. Preferably the light source should include an inbuilt power supply, such as a battery, that provides sufficient illumination for lengthy night rides without the need of frequently replacing or recharging the battery. The light source should also sufficiently illuminate the path in front of the horse, thereby making the horse and the rider clearly visible to oncoming motorists, other riders, or pedestrians.

The pouch is made of single cross-shaped sheet, wherein the sheet mainly comprises a plurality of flaps, straps, buckles or D-rings, and several openings comprising apertures and cutouts. In a preferred embodiment, the sheet comprises four flaps, namely, left, right, top, and bottom flaps. The pouch can be formed by securing the left and right flaps to the side-ends of the bottom flap and by releasably securing the top flap to the bottom flap. The straps and buckles or D-rings are attached to the pouch at several locations along the back side of the apparatus. The straps in conjunction with the buckles are used to secure the pouch to the breast collar of a horse. The light from the light source protrudes from the openings or cutouts defined on the top and bottom flaps.

### BRIEF DESCRIPTION OF THE FIGURES

FIGS. 1a and 1b are illustrations of plan views of the pouch in its disassembled state in accordance with the present invention.

FIG. 2 is an illustration of the assembled pouch, with the top flap open to accommodate a compact light source in accordance with the present invention.

FIG. 3 is an illustration of the assembled pouch, with the top flap closed to complete the pouch and secure a light source within the pouch in accordance with the present invention.

FIG. 4 is an illustration of a light source.

FIG. 5 is an illustration of the pouch holding the light source with the top flap opened.

FIG. 6 is an illustration of the pouch holding the light source with the top flap secured to the bottom flap.

### FIGURES—REFERENCE NUMERALS

10 . . . Light Source
11 . . . Pouch
12 . . . Cross-Shaped Sheet
13 . . . Strap
14 . . . Buckle or D-ring
15 . . . Aperture
16 . . . Flap
17 . . . Snap
18 . . . Flap Connection Location/Stitching Location
19 . . . Aperture
20 . . . Power Supply Portion
21 . . . Light-emitting Portion

### DETAILED DESCRIPTION

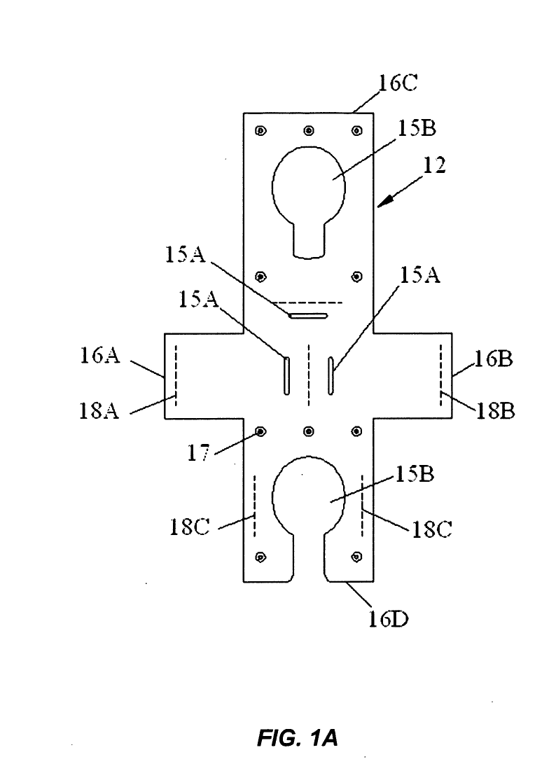

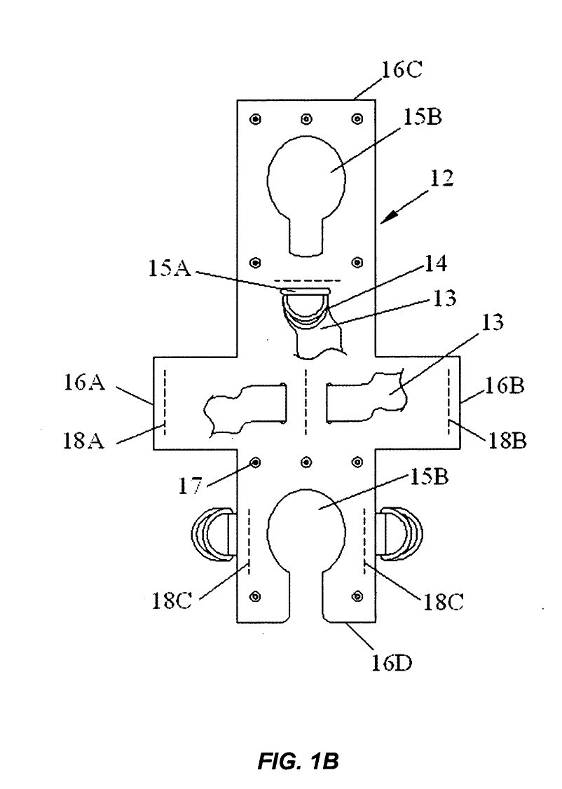

Referring to the drawings, the preferred embodiment of an improved light apparatus that increases safety during nighttime horse rides is illustrated in FIGS. 1 through 6. The apparatus generally comprises a light source 10 and a pouch 11 for holding the light source 10. The pouch 11 is made of a single cross-shaped sheet 12, which comprises a plurality of straps 13, buckles or D-rings 14, and apertures or openings 15. In accordance with the present invention, the sheet 12 can be made from any durable material, preferably leather.

Referring to FIG. 1A, the sheet 12 mainly comprises four flaps 16, which can be categorized in to left, right, top, and bottom flaps. The pouch is formed by securing the left and right flaps, 16A and 16B, to the side-ends of the bottom flap 16D, followed by releasably securing the top flap 16C with the bottom flap 16D. The left and right flaps, 16A and 16B, can be secured to the side-ends of the bottom flap 16D by sewing, whereas snaps 17 or similar structures can be used to releasably secure the top flap 16C with the bottom flap 16D. These snaps 17 are provided at suitable locations on the top and bottom flaps.

A first group of openings or cutouts 15A will be located in three locations, two in a parallel orientation in the middle portion of the sheet 12 and one on the top flap 16C. The straps 13 are made to pass through these openings or cutouts 15A, following which they are sewn on to the sheet 12, as illustrated in FIG. 1b. The straps 13 will be the primary method for attaching the pouch 11 directly to the breast collar of a horse. A second group of openings or apertures 15B will be located at the distal ends of the top and bottom flaps, 16C and 16D. These apertures 15B facilitate the protrusion of the cowl of the light 21 after it has been inserted and secured in the pouch 11.

The buckles or D-rings 14 and straps 13 are also sewn to the sheet 12 at suitable locations for attaching to varying sizes of breast collars. The straps 13 are preferably made from non-perforated Nylon webbing for D-rings and/or Nylon webbing with centerline holes for buckles to secure to. The buckles or D-rings 14 will be attached using matching Nylon webbing materials same as that of the straps 13.

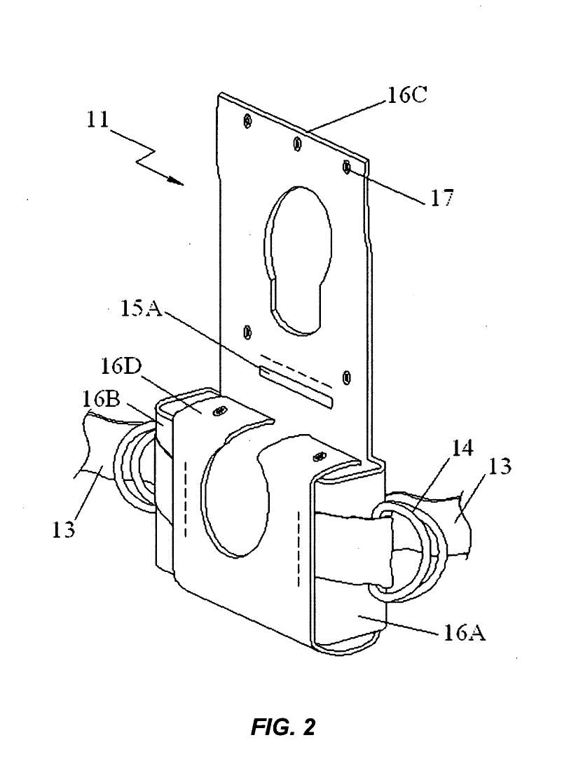

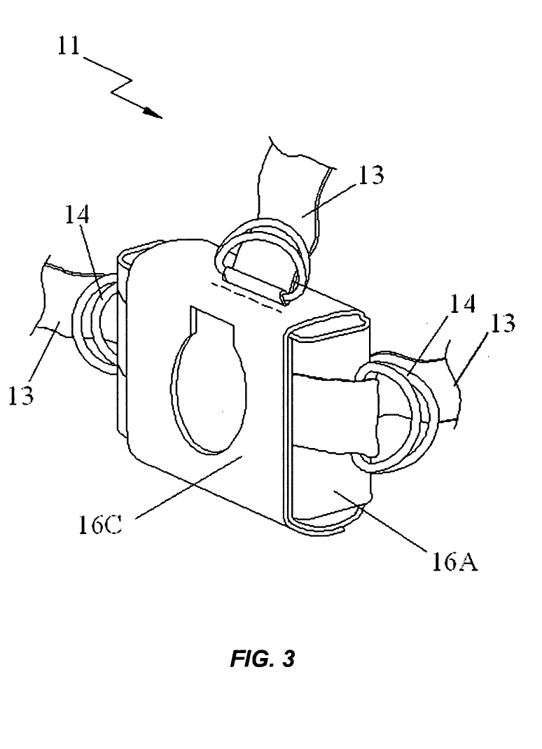

Referring to FIG. 2, the pouch 11 is formed by attaching the distal ends of the left and right flaps, 16A and 16B, to the side-ends of the bottom flap 16D. The stitching locations on the left, right, and bottom flaps, 18A, 18B, and 18C respectively, for this attachment are shown. To complete the assembly, the top flap 16C is secured to the bottom flap 16D with snaps 17 forming the pouch 11, as seen in FIG. 3. The openings or cutouts 15B formed at the distal ends of the top and bottom flaps, 16C and 16D, overlap and provide an aperture 19.

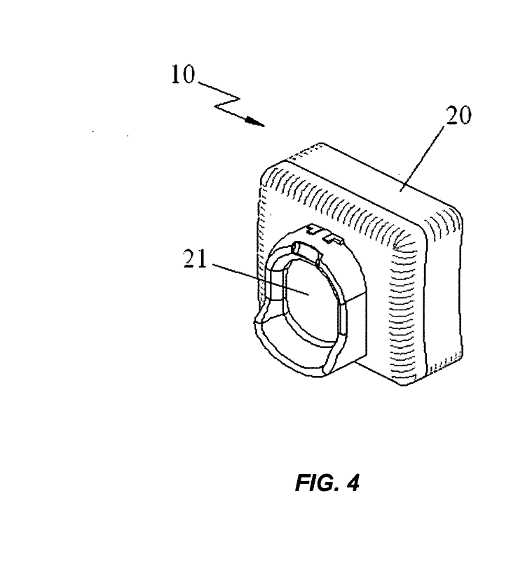

The light source 10, is shown in FIG. 4. Typically the light source 10 includes a power supply portion 20, for example a portion for receiving batteries with the related hardware, and a light-emitting portion 21. In a preferred embodiment, any state-of-the-art battery powered LED light source suitable for insertion into the pouch can be used in accordance with the present invention. However, any light source should provide sufficient illumination for an extended distance in front of the horse, and should have a battery life of several hours. The light should be bright enough to be visible to oncoming motorists, other riders, or pedestrians. The light source may also include multiple settings such as a flashing light signal.

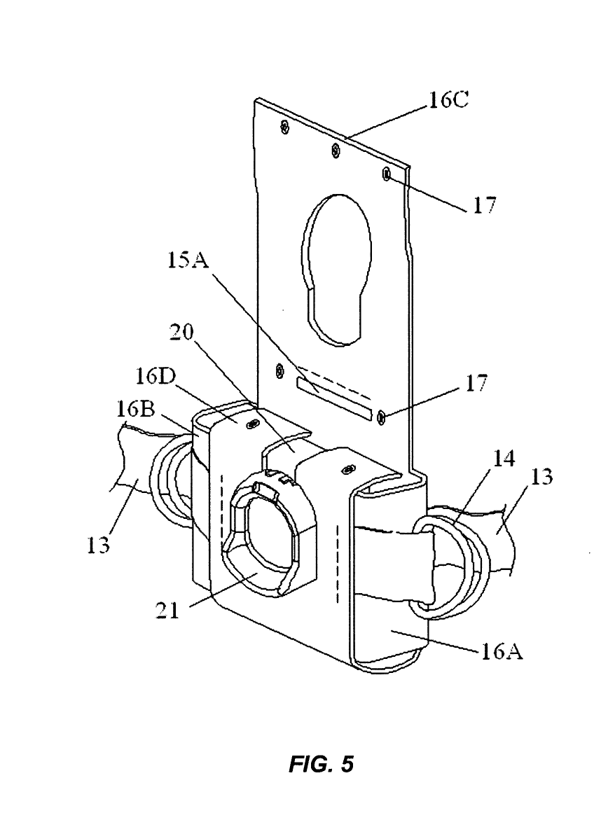

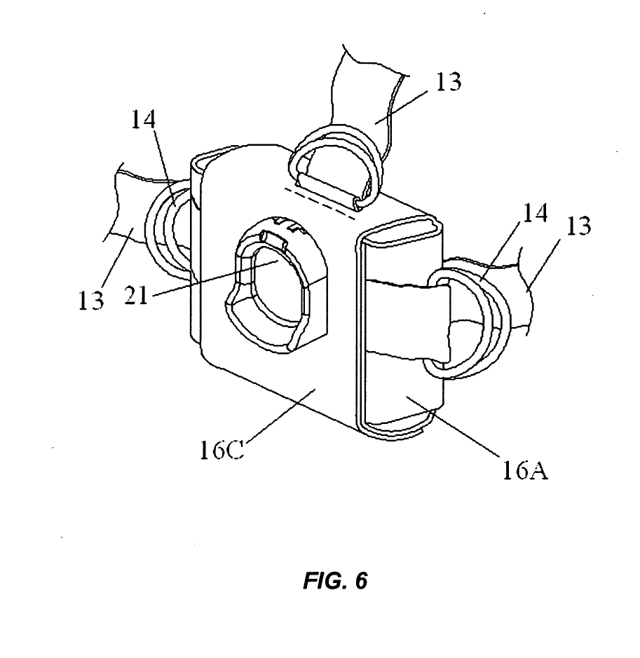

Referring to FIG. 5, the light source 10 is inserted into the pouch 11 such that the light-emitting portion 21 protrudes from the aperture 19. Following which the top flap 16C is secured to the bottom flap 16D as illustrated in FIG. 6. The pouch 11 can be secured to the breast collar of a horse using the straps 13 and the buckles or D-rings 14. The light source 10 can be removed from the pouch 11 to have its batteries changed, and for other emergency purposes while still keeping the pouch 11 attached to the horse's breast collar. In addition, the apertures 19 are cut out to provide access to the top of the cowl of the light source 10 where control switches are typically located. This enables a rider to reach around the horse's neck and change settings on the light without removing the apparatus.

Several structural variations and dimensions of the apparatus are possible. For example, the pouch can be formed in different sizes and shapes to firmly hold larger or smaller light sources. Also, an alternate number of straps, buckles or D-rings, and snaps may be selected. Different lengths and widths of the straps can be chosen to firmly secure the pouch to the breast collar of the horse. Moreover, many materials and matching colors can be used for the pouch, straps, and buckles or D-rings.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

While specific apparatus has been disclosed in the preceding description, it should be understood that these specifics have been given for the purpose of disclosing the principles of the present invention and that many variations thereof will become apparent to those who are versed in the art. Therefore, the scope of the present invention is to be determined by the appended claims.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

What is claimed is:

1. An improved nighttime safety light for horses comprising:
an compact illuminating light source with a built-in power supply;
a pouch for holding the light source, defined by a cross-shaped folding structure with fasteners and an overlapping aperture through which the illuminating light protrudes and illuminates;
a first fastening means consisting of an elongated strap-like member threaded horizontally through the center of the rear side of the pouch and terminating in two connecting ends;
a pair of shorter corresponding straps extending from the side of pouch with corresponding connecting ends that connect the shorter straps to the elongated strap-like member; and
a second fastening means consisting of a looping strap and connecting means descending vertically from the bottom rear of the pouch; third a plurality of buckle-like members or D-rings attached to the pouch at plurality of locations.

2. The improved nighttime safety light of claim 1, wherein the pouch is formed of a single foldable cross-shaped sheet with horizontal and vertical members, with apertures in the bottom and top vertical members, the horizontal members ends of the sheet fold inward to comprise the sides and a portion of the front of the apparatus, and the top and bottom vertical members fold downward and upward, respectively, to form the top, bottom and front side of the apparatus, wherein the apertures overlap to engage the cowl of a lighting device contained in the apparatus and the center of the cross shaped sheet comprises the rear of the apparatus.

3. The improved nighttime safety light of claim 1, wherein a pair of slits is disposed in a vertical parallel orientation in the center of the cross-shaped sheet through which the elongated strap-like member extends, so that the extremities of the strap-like member extent outward from the slits and away from the safety light, and the middle of the strap is fastened to the center of the cross-shaped sheet.

4. The improved nighttime safety light of claim 1, wherein the extremes of the horizontal members of the cross-shaped sheet are fastened to the mid-section of the bottom vertical member of the cross-shaped sheet, thereby forming the cross-shaped sheet into a pouch, with the top vertical member hingedly closable over the top of the pouch.

5. The improved nighttime safety light of claim 1, wherein the top member of the cross-shaped sheet can be hingedly articulated and releasably secured over the front and bottom of the safety light, thereby allowing the compact illuminating light source to be inserted into the safety light apparatus, and secured therein, as well as removed for replacement while maintaining the safety light in connection with a horse breast collar or other surface.

6. The improved nighttime safety light of claim 1, wherein the sheet comprises leather, denim, nylon, or canvas.

7. The improved nighttime safety light of claim 5, wherein the pouch wherein the securing mechanism for the opening and closing vertical member of the cross-shaped sheet comprises snaps, and the securing mechanism for the elongated strap-like member, corresponding straps and looping strap are connected and fastened by a “D” ring fastener, buckle or compression fasteners.

8. The improved nighttime safety light of claim 1, wherein the horizontal members of the cross-shaped sheet are fastened to the bottom vertical member with stitching to form the pouch of the light apparatus.

9. The improved nighttime safety light of claim 1, wherein the elongated strap-like member, corresponding straps and looping strap are made of nylon.

10. The improved nighttime safety light of claim 1, wherein the elongated strap-like member, corresponding straps and looping strap are secured to the cross-shaped sheet with stitching.

11. A method of increasing safety when riding a horse at night through the use of an improved nighttime safety light apparatus, comprising the steps of;
unsnapping the top flap of an improved nighttime safety light apparatus, and inserting a compact battery powered light source so that the cowl of the light protrudes through the aperture of the apparatus;
replacing the top flap over the pouch, and snapping the top flap over the front and bottom of the apparatus;
securing the apparatus to the breast collar of a horse by drawing the straps around the center ring of the breast collar and securing them with the connecting mechanisms of the apparatus; and
switching the light to the desired setting to illuminate the area in front of the horse.
